(19) United States
(12) Patent Application Publication
(10) Pub. No.: US 2021/0208778 A1
(43) Pub. Date: Jul. 8, 2021

(54) CONTIGUOUS PLANAR DISPLAY OPERABLE TO HAVE AREA FUNCTIONING AS PRIMARY DISPLAY AND AREA FUNCTIONING AS SECONDARY DISPLAY

(71) Applicant: HEWLETT-PACKARD DEVELOPMENT COMPANY, L.P., Spring, TX (US)

(72) Inventors: Mario CAMPOS, Houston, TX (US); Ron ZHANG, Palo Alto, CA (US); Scott RAWLINGS, Fort Collins, CO (US); Bruce BLAHO, Fort Collins, CO (US); Monji JABORI, Houston, TX (US)

(73) Assignee: HEWLETT-PACKARD DEVELOPMENT COMPANY, L.P., Houston, TX (US)

(21) Appl. No.: 16/075,604

(22) PCT Filed: Jun. 29, 2017
(86) PCT No.: PCT/US2017/039965

§ 371 Date: Aug. 4, 2018

(51) Int. Cl. G06F 3/0488; G06F 9/451; G09G 3/20

(52) U.S. Cl. CPC G06F 3/04886; G06F 9/451; G09G 2330/026; G06F 2203/04803; G06F 2203/04104; G09G 3/20

(57) ABSTRACT

A display device having a contiguous planar display is operable in a selectable mode in which the planar display has a first area functioning as a primary display and a second area coplanar with and smaller than the first area functioning as a secondary display separate from the primary display. A computing device is to operate the display device in the selectable mode by using the first area of the planar display as a primary graphical user interface (GUI) area and by using the second area of the planar display in the selectable mode as a secondary GUI area isolated from the primary GUI area.

### BACKGROUND

Display devices for computing devices include external display devices commonly used with desktop computers as well as integrated display devices disposed in notebook, tablet, and convertible or hybrid notebook computers, the latter which can be used as both traditional notebook computers via keyboard or as tablet computers. A common form factor of the displays of such display devices is a widescreen form factor, such as one having a 16:9 aspect ratio, and less frequently a 16:10 aspect ratio. The computing industry has settled on such aspect ratios for a variety of different reasons, not the least of which is that much video content has a widescreen form factor, which means that viewing the video content on such displays can be achieved with little or no letterboxing. Letterboxing is the process of displaying black bars at the top and bottom of the display to preserve the original aspect ratio of video content on a display that does not have the same aspect ratio.

### BRIEF DESCRIPTION OF THE DRAWINGS

FIG. 1 is a block diagram of an example system including a display device and a computing device.

FIG. 2 is a diagram of an example contiguous planar display of a display device operating in a selectable mode in which the display has a first area functioning as a primary display and a second area functioning as a secondary display.

FIG. 3 is a diagram of an example implementation of a contiguous planar display of a display device operating in a selectable mode in which the display has a first area functioning as a primary display and a second area functioning as a secondary display.

FIG. 4 is a diagram of an example operation of a contiguous planar display of a display device in a selectable mode in which a first area of the display is being used by a computing device as a primary graphical user interface (GUI) area and a smaller second area of the display is being used by the computing device as a secondary GUI area.

FIG. 5 is a diagram of another example operation of a contiguous planar display of a display device in a selectable mode in which a first area of the display is being used by a computing device as a primary GUI area and a smaller second area of the display is being used by the computing device as a secondary GUI area.

FIG. 6 is a diagram of an example operation of a contiguous planar display of a display device in a different selectable mode in which an entire area of the display is being used by a computing device as a primary GUI area.

FIG. 7 is a diagram of an example pre-boot environment operation of a contiguous planar display of a display device in a selectable mode in which a first area of the display is being used by a computing device as a primary GUI area and a smaller second area of the display is being used by the computing device as a secondary GUI area.

### DETAILED DESCRIPTION

As noted in the background section, display devices for computing devices frequently have a widescreen form factor, such as that having a 16:9 aspect ratio. While this aspect ratio permits for optimal viewing of more video content using such computing devices, the widescreen form factor has proven to be less than optimal for productivity purposes, including content creation. Because of the wide availability and hence lower cost of widescreen displays, however, even computing devices that are intended primarily for productivity, such as business-class notebook, tablet, and convertible or hybrid notebook computers, commonly include widescreen displays.

Disclosed herein are techniques that permit widescreen displays of display devices to be used more optimally by computing devices for productivity and other purposes. A display device has a contiguous planar display, such as a widescreen display. The display is operable in a selectable mode in which the planar display has a first area and a second area that is coplanar with the first area. The first area functions as a primary display, whereas the second area, which is smaller than the first area, functions as a secondary display separate from the primary display. For instance, the first area may have a 3:2 aspect ratio, whereas the second area may have a 5:18 aspect ratio.

A computing device can operate the display in this selectable mode by using the first area as a primary graphical user interface (GUI) area, and by using the second area as a secondary GUI area isolated from the primary GUI area. Disclosed herein are different manners by which the contiguous planar display of a display device can operate in such a selectable mode in which first and second areas of the display function as coplanar primary and secondary displays that are separate from one another. Also disclosed herein are different usage scenarios in which a computing device can operate this display in the selectable mode by using the first and second areas as primary and secondary GUI areas, respectively, that are isolated from one another.

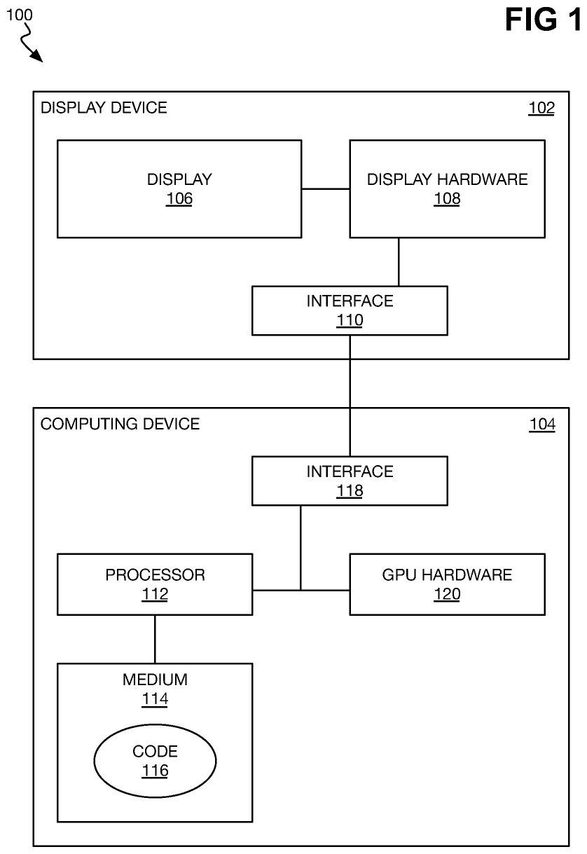

FIG. 1 shows an example system 100 that includes a display device 102 and a computing device 104. The display device 102 may be an external display device for the computing device 104, or may be integrated with the computing device 104. An example of the former is an external monitor for a desktop computer. Examples of the latter include notebook computers including keyboards, tablet computers not including keyboards, and hybrid or convertible notebook computers that include keyboards but which can be used as traditional notebook computers via keyboard or as tablet computers. Other examples of the display device 102 being integrated with the computing device 104 include a mobile computing device like a smartphone, as well as an all-in-one (AIO) computer primarily intended for stationary placement on a desktop or table, and which includes a relatively large display device in which a computing device is integrated.

The display device 102 can include a display 106, display hardware 108, and an interface 110. The display is a contiguous planar display 106. The display 106 can be planar in that the surface of the display 106 is and is used as a single plane, as opposed to multiple planes that are parallel or non-parallel to one another. The display 106 can be contiguous in that portions, sections, or areas of the display 106 abut one another without separation. For instance, the right-most pixels of a first portion of the display 106 can be immediately adjacent to the left-most pixels of a second portion of the display 106 to the immediate right of the first portion at the same distance at which the second-to-right most pixels of the first portion are adjacent to the right-most pixels of the first portion.

The display 106 can thus be implemented as one or more physical display panels, such as liquid crystal display (LCD) display panels, organic light-emitting diode (OLED) display panels, microscopic LED (mLED, microLED, or micro-LED) display panels, quantum dot LED (QLED) display panels, and other types of flat display panels. The display 106 can be a touchscreen display, such as a touch-sensitive display have multi-touch capability. A multi-touch display is able to register and detect the locations of multiple touches on the display by a user. A touchscreen display may be employed with a stylus, for more precise usage of the display by a user as compared to the user using his or her fingers to touch the display. The display 106 may have integrated sensory haptic technology as well. The display 106 can further have adaptive sync technology that eliminates screen tearing.

The display hardware 108 can be or include scaler hardware, timing controller hardware, and other types of controller hardware 108 to control the display 108 in accordance with video or display signals received at the interface 110. Scaler hardware, for instance, can convert video signals from one display resolution to another resolution, such as the native resolution of the display 106. Timing controller hardware can generate the timing of video signals, such as the horizontal and vertical synchronization signals, and the blanking interval signals that are employed to facilitate the generation of images displayed on the display 106.

The interface 110 can include one or more physical interfaces, at which the display hardware 108 of the display device 102 receives display or video signals from the computing device 104. When the display device 102 is an external monitor for a separate computing device 104, such physical interfaces can include the high-definition multimedia interface (HDMI), the DisplayPort digital display interface, the digital video interface (DVI), among other interfaces. When the display device 102 is integrated with the computing device 104, such physical interfaces may be proprietary ribbon cable connectors and other types of interfaces, which may still hew to HDMI, DisplayPort interface, or DVI standards but with non-standard physical form factors.

The computing device 104 can include a processor 112, a non-transitory computer-readable data storage medium 114 storing program code 116, an interface 118, and graphical processing unit (GPU) hardware 120. The processor 112 can be a general-processing central processing unit (CPU) that executes the program code 116 stored on the medium 114. The medium 114 can include volatile and non-volatile media, such as semiconductor memory like flash memory as well as dynamic random access memory (DRAM), and magnetic media like hard disk drives.

The interface 118 can include one or more physical interfaces, at which the computing device 104 provides display or video signals to the display device 102. When the computing device 104 is separate from the display device 102, the physical interfaces can include HDMI, the DisplayPort interface, and DVI. When the computing device 104 is integrated with the display device 102 as a single computer, the physical interfaces may be proprietary ribbon cable connectors and other types of interfaces, which may still hew to HDMI, DisplayPort interface, or DVI standards but with non-standard physical form factors. The processor 112 and/or the GPU hardware 120, if present, provide the display or video signals on the interface 118.

The GPU hardware 120 can assist the processor 112 in rapidly manipulating and altering memory to accelerate the creation of images in a frame buffer for output to the display device 102 via the interface 118. In this respect, the GPU hardware 120 can be considered a special-purpose processor that can perform specialized processing for which the hardware 120 is designed more quickly than the general-purpose processor 112 can. For instance, the GPU hardware 120 may have highly parallel structures that makes the hardware 120 more efficient than a general-purpose CPU for processing large blocks of video or display data in parallel.

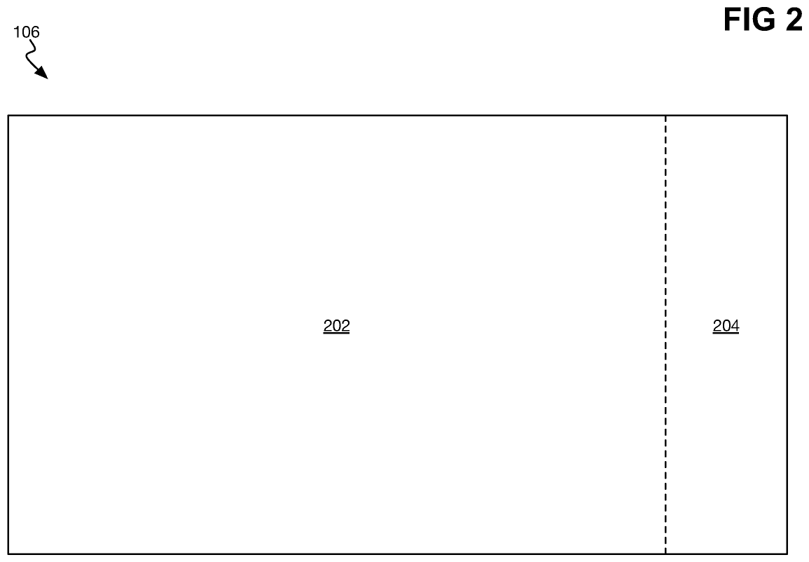

FIG. 2 shows an example contiguous planar display 106 of the display device 102 operating in a selectable mode. In the example of FIG. 2, the display 106 has a widescreen form factor with a 16:9 aspect ratio. In this selectable mode, the display 106 has a first area 202 and a second area 204. The first area 202 functions as a primary display, and the second area 204 functions as a secondary display separate from the primary display of the first area 202. In the example of FIG. 2, the first area 202 having the primary display has a 3:2 aspect ratio, whereas the second area 204 having the separate, secondary display has a 5:18 aspect ratio.

In the example of FIG. 2, the contiguous planar display 106 is operating in landscape mode, and the second area 204 is to the right of the first area 202 in the selectable mode in which the display device 102 is operating. For example, a left-handed user may use a stylus in his or her left hand in the first area 202, and use the fingers of his or her right hand in the second area 204. However, the second area 204 can be user-selected to instead be to the left of the first area 202 in this selectable mode of the display device 102. For example, a right-handed user may use a stylus in his or her right hand in such a right-most first area 202, and use the fingers of his or her left hand in a left-most second area 204.

The contiguous planar display 106 can also operate in portrait mode, in which the display 106 is operated vertically instead of horizontally as depicted in FIG. 2. For example, if the display device 102 is integrated with the computing device 104 as a tablet computer or a convertible or hybrid notebook computer currently being operated as a tablet computer, the user can simply rotate the computer to operate the display 106 in portrait mode instead of in landscape mode. In portrait mode, the second area 204 having the separate, secondary display may be below or above the first area having the primary display, as configured by the user.

In one implementation, the processor 112 of the computing device 104 executes the program code 116 stored on the non-transitory computer-readable medium 114 to realize the selectable mode of the display device 102 in which the first area 202 of the display 106 functions as a primary display and the second area 204 functions as a separate, secondary display. In this implementation, the processor 112 executes the code 116 to divisibly virtualize the display 106 into the first area 202 and the second area 204. The code 116 may be executed at the level of the operating system running on the computing device 104, at the level of the driver for the display device 102 running on the computing device 104, between these two levels, above the operating system level, or below the driver level.

For example, if operating between the driver level and the operating system level, the program code 116 may virtualize the display 106 as exposed by the driver for the display device 102 as two separate displays: the primary display of the first area 202 and the separate, secondary display of the second area 204. Therefore, the operating system may not be able to see the display 106 exposed by the driver for the display device 102 any longer while the display device 102 is operating in the selectable mode, but rather sees the primary display and the separate, secondary display, as if they were themselves different display devices. This similarly occurs if the program code 116 operates at the driver level, in which the driver for the display device 102 may itself include the code 116 so that the driver exposes the primary and separate, secondary displays instead of the display 106 of the display device 102.

If operating below the driver level, the program code 116 may virtualize the display 106 as the primary display and the separate, secondary display by directly intercepting the information provided by the display device 102 at the interface 110, converting this information to instead reveal two displays to one or more drivers. Therefore, rather than there being a driver for the display 106 of the display device 202, there may be a driver for the primary display of the first area 202 and a driver for the separate, secondary display of the second area 204. In this case, the operating system again sees the primary display and the separate, secondary display as if they were themselves different display devices.

If operating at the operating system level, the program code 116 may virtualize the display 106 as the primary display and the separate, secondary display by manipulating the display 106 as revealed or exposed by the driver for the display device 102. If operating above the operating system level, the code 116 may be disposed between the operating system and application and other programs running on the operating system. The code 116 may force such programs to just operate within the first area 202, and permit a program designed to control the second area 204—and other programs sanctioned by this program—to operate within the second area 204.

In another implementation, the GPU hardware 120 of the computing device 104 realizes the selectable mode of the display device 102 in which the first area 202 of the display 106 functions as a primary display and the second area 204 functions as a separate, secondary display. In this implementation, the GPU hardware 120 is programmed to divisibly virtualize the display 106 into the first area 202 and the second area 204. Insofar as the operating system running on the computing device 104 (i.e., via the processor 112) interacts with the display device 102 via the GPU hardware 120, the virtualization of the display 106 of the display device 102 by the GPU hardware 120 exposes the display 106 instead as the primary and separate, secondary displays, as if the primary and secondary displays were separate physical displays of the display device 102.

In a third implementation, the display hardware 108, such as the scaler or timing controller hardware, of the display device 102 exposes the contiguous planar display 106 to the computing device 118 as the primary display and the separate, secondary display at the interface 110 of the display device 102. Therefore, the computing device 104 sees the display device 102 as two separate physical displays: the primary display of the first area 202 and the separate, secondary display of the second area 204. This is the case even though the contiguous planar display 106 may be a single such physical display in this implementation.

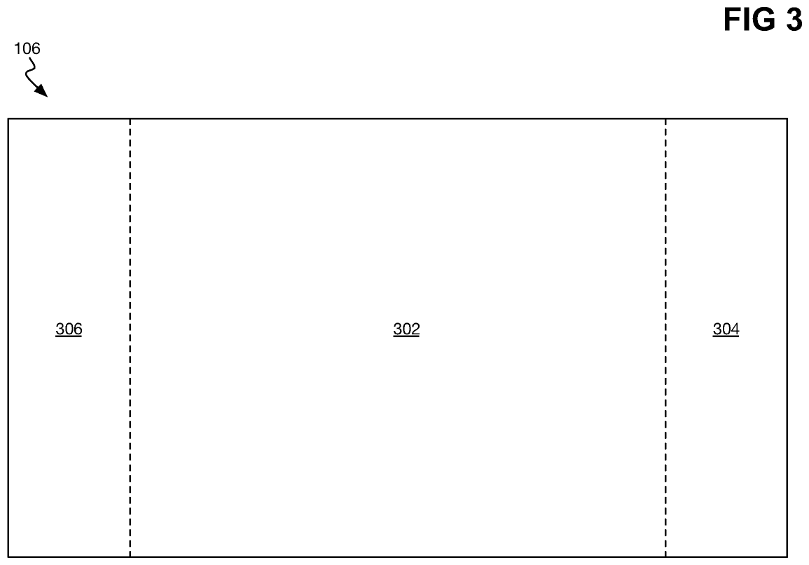

FIG. 3 shows an example contiguous planar display 106 of the display device 102 to realize the first area 202 and the second area 204 in a fourth implementation. In the example of FIG. 3, the display 106 includes at least three separate physical displays 302, 304, and 306 that are contiguously arranged as depicted. Each separate display 302, 304, and 306 may be a separate LCD, OLED, or other type of display panel. The middle display 302 is larger than each of the displays 304 and 306, which are equal in size. If the display 106 itself has a 16:9 aspect ratio, then each of the displays 304 and 306 can have a 5:18 aspect ratio, and the display 302 can have an 11:9 ratio.

In the fourth implementation to realize the first area 202 and the second area 204, the display hardware 108 exposes at the interface 110 one contiguous subset of the displays 302, 304, and 306 as the primary display of the first area 202, and another contiguous subset of the displays 302, 304, 306 as the separate, secondary display of the second area 204. The computing device 104 sees the display device 102 as two separate physical displays—the primary display of the first area 202 and the secondary display of the second area 204—even though there are more than two such physical displays. For example, if the second area 204 is to the right of the first area 202 as shown in FIG. 2, then the displays 306 and 302 are exposed as a single primary display, and the display 304 is exposed as a single and separate secondary display. By comparison, if the second area 204 is configured by the user to be to the left of the first area 202, then the displays 302 and 304 are exposed as the single primary display, and the display 306 is exposed as a single and separate secondary display.

Therefore, in this implementation, there are multiple actual physical displays that constitute the display 106, and the display hardware 108 of the display device 102 exposed two different subsets of these physical displays to the computing device 104 at the interface 110 as the primary display of the first area 202 and as the second display of the second area 204. In the case in which there are three physical displays 302, 304, and 306 implementing the display 106, the subset exposed as the single primary display includes the larger middle display 302 and one of the smaller displays 304 and 306. The subset exposed as the single and separate secondary display includes the smaller display 304 or 306 that is not part of the subset exposed as the single primary display.

The implementations that have been described provide for different manners by which a display device 102 having a contiguous planar display 106 can operate in a selectable mode in which the planar display 106 has a first area 202 functioning as a primary display and a smaller and coplanar second area 204 functioning as a secondary display. The primary and secondary displays are separate from one another. For instance, a computing device 104 connected to the display device 102 may virtualize the displays so that they are separate from one another, or the display device 102 may expose the displays to the computing device 104 as if they were separate physical displays, as has been described above.

However, regardless of implementation, the computing device 104 connected to the display device 102 can operate the display device 102 in this selectable mode by using the first area 202 of the planar display 106 as a primary GUI area and by using the second area of the planar display 106 as a secondary GUI area. The primary and secondary GUI areas are isolated from one another. This can mean that GUI elements, such as windows, controls, buttons, dialog boxes, and so on, cannot bleed over or be moved from the primary GUI area to the secondary GUI area and vice-versa. This can also mean that the primary GUI area displays a GUI that is distinct and different from a GUI that the secondary GUI area displays.

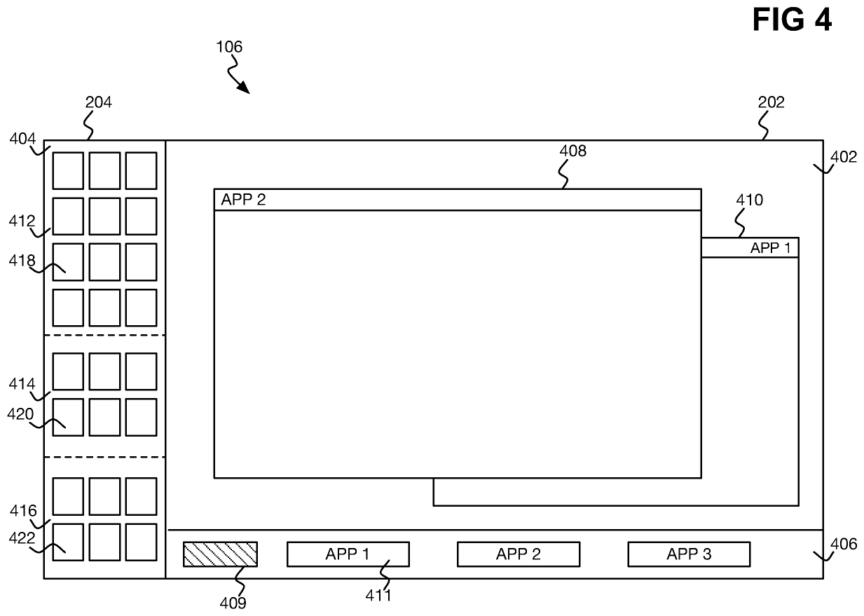

FIG. 4 shows an example operation of the display device 102 in the selectable mode in which the computing device 104 uses the first area 202 of the contiguous planar display 106 as a primary GUI area 402 and the second area 204 of the planar display 106 as an isolated secondary GUI area 404. In the example of FIG. 4, the second area 204 is to the left of the first area 202, as opposed to being to the right of the first area 202 as in FIG. 2, for instance. As such, the example of FIG. 4 may be more suited for right-handed users, since the primary GUI area 402 that may receive most user interaction is located on the right side of the display 106. The computing device 104 may achieve the example operation of FIG. 4 by executing the code 116 stored on the medium 114 to operate the primary display of the first area 202 of the display 106 as the primary GUI area 402, and by executing the code 116 to operate the secondary display of the second area 204 as the secondary GUI area 404.

In the primary GUI area 402, an operating system running on the computing device 104 can expose GUI elements such as a taskbar 406. The taskbar 406 can include a start or main button 409 that selection of which calls up a primary program selection menu proffered through the operating system. The taskbar 406 can include buttons or icons 411 corresponding to actively running application programs on the computing device 104 via the operating system. In the primary GUI area 402, the operating system can display GUI elements such as windows 408, 410 for the actively running application programs. In the example of FIG. 4, the application program having the window 408 currently has focus since it is the top-most window. This can mean that user input via a keyboard, for instance, is directed to this application program.

The GUI elements of the primary GUI area 402 cannot be moved onto, over, or into the secondary GUI area 402, and further are not extendible into the secondary GUI area 404, because the secondary GUI area 404 is isolated from the primary GUI area 402. Such isolation occurs at least at the operating system level. However, the separation of the primary display that the first area 202 functions as from the secondary display that the second area 204 functions as can contribute to this isolation. For instance, if the primary and secondary displays are exposed to the computing device by the display device 102 as if they are different physical displays, then this separation of the primary and secondary displays can permit the operating system to more easily isolate the primary and secondary GUI areas 402 and 404. As another example, if the computing device 104 itself virtualizes the first and second areas 202 and 204 as separate primary and secondary displays, then this virtual separation can permit the operating system to more easily isolate the GUI areas 402 and 404.

The secondary GUI area 404 can have a different GUI paradigm than the primary GUI paradigm. In the secondary GUI area 404, there may be three areas: an area 412 corresponding to the application program that currently has focus within the primary GUI area 402; an area 414 corresponding to other application programs that are background-running on the computing device 102; and an area 416 corresponding to the operating system of the computing device 102 itself. A user may select among these three areas that are to be displayed within the secondary GUI area 404. For instance, to maximize space for the area 412, the user may turn off or otherwise decide not to have displayed the areas 414 and/or 416. As another example, if the user does not need access to application programs that are running in the background on the computing device 102, the user may turn off the area 414 or otherwise decide not to have the area 414 displayed. The user may further be able to resize the areas 412, 414, and 416, so that more space is given to selected of the areas 412, 414, and 416 at the expense of the other of the areas 412, 414, and 416.

The secondary GUI area 404 displays in the area 412 operable GUI controls 418 particular to the application program that currently has focus in the primary GUI area 402 of the first area 402 of the planar display 202. In the example of FIG. 4, this is the application program having the top-most window 408 within the primary GUI area 402. As the application program having focus in the primary GUI area 402 changes, the operable GUI controls 418 displayed in the area 412 may correspondingly change as well to be relevant or particular to the program that currently has focus in the primary GUI area 402.

The operable GUI controls 418 may be in the form of buttons and other types of controls, including search boxes, slider controls, color wheels, and so on. Inclusion of the operable GUI controls 418 within the secondary GUI area 404 can render their presence within the window 408 in the primary GUI area 402 unnecessary, freeing up space in the window 408 for the primary task of the application program. For instance, controls that are typically included in a ribbon-type bar within the primary GUI area 402 may instead be relegated to the secondary GUI area 404.

As an example, an application program may be a drawing or illustration program. A user may be creating a drawing or illustration within the window 408 of the application program in the primary GUI area 402. The user can select from different controls for creating different parts of the drawing or illustration via the operable GUI controls 418 in the area 412 of the secondary GUI area 402. For instance, the user may be holding a stylus in his or her right hand to improve precision when creating or editing the drawing or illustration within the window 408 in the primary GUI area 402, while selecting the controls operable GUI controls 418 in the area 412 of the secondary guide area 404 using the fingers of his or her left hand.

This example is particularly suitable for usage of a display device 102 and a computing device 104 integrated within a system 100 that is in the form of a tablet or a hybrid or convertible notebook computer being used as a tablet. It is noted that an issue that is not uncommonly experienced by users that draw on the touchscreen displays of such tablets using styluses is the undesired registration of touch by the users' hands resting on the displays while holding the styluses. For example, when a user holds a stylus in his or her hand and draws on a display, in addition to the tip of the stylus touching the display, a portion of the user's hand does as well. This is problematic, as it can affect the ability of the user to naturally use a stylus with a tablet.

Operating the display device 102 in a selectable mode in which the first area 202 functions as a primary display and the second area 204 functions as a separate, secondary display provides for a way to overcome this issue. Particularly, the multi-touch capability of the planar display 106 within the first area 202 can be disabled, while still enabling the multi-touch capability of the display 106 within the second area 204. For instance, this can mean ignoring or suppressing multi-touch of the display 106 within just the first area 202 and not within the second area 204, at either the display device or the computing device level.

Therefore, the user is still able to use multi-touch capability within the second area 204, which means that selection of operable GUI controls within the secondary GUI area 404 via user finger touch is still permitted. By comparison, multi-touch capability within the first area 202 is disabled, which means that while single point touch detection of a stylus within the first area 202 is permitted for drawing and other purposes within the primary GUI area 402, other types of touch are suppressed or otherwise ignored. For example, a user resting the edge of the hand holding the stylus on the display 106 within the first area 202 will not register undesired touches within the primary GUI area 402 that can detract from the usage of the stylus. As such, the clear division of multi-touch disablement and enablement between the first and second areas 202 and 204 promotes an improved user experience.

Still referring to FIG. 4, the secondary GUI area 404 displays in the area 414 operable GUI controls 420 particular to application programs that are running in the background on the computing device 102. The operable GUI controls 418 may be in the form of buttons and other types of controls, including search boxes, color wheels, slider controls, and so on. For instance, such application programs may by those that do not currently have focus in the primary GUI area 402 of the first area 402 of the planar display 106. Such an application program may be launched via the operating system and on the primary GUI area 402, and may have an icon 411 within the taskbar 406 in the primary GUI area 402 that selection of which causes a corresponding window to be displayed within the primary GUI area 402.

However, rather than user selection of the icon 411 to display the window (or other GUI element) for interaction with the application program, the presence of the operable GUI controls 418 within the area 414 of the secondary GUI area 404 permits the user to interact with the program outside of the primary GUI area 402. For instance, a music program may play music in the background. To receive information from the music program, such as the name and artist of the current song, and to interact with the program, such as to skip to the next song, the user may ordinarily have to select an icon 411 for the music program to call up a corresponding GUI element within the primary GUI area 402. The user then has to locate the desired information or GUI control, before dismissing the GUI element to continue working on the application program with which the user was interacting in the primary GUI area 402 previously. Locating the operable GUI controls 418 for this music program within the secondary GUI area 404 instead permits the user to more easily interact with the program with less impact on the user's interaction with a different program within the primary GUI area 402.

The application programs for which there are operable GUI controls 420 within the area 414 of the secondary GUI area 404 can include widget application programs that are background-running on the computing device 104. Widget application programs can include programs that are exclusively accessed within the secondary GUI area 404, and that do not have aspects accessible within the primary GUI area 402. For instance, standalone clock, calculator, and other types of utility programs may be exclusively accessed within the secondary GUI area 404.

In general, access to the secondary GUI area 404, including to the area 412 by the application program that currently has focus within the primary GUI area 402 and/or to the area 414 for application programs that are running in the background on the computing device 102, may be afforded via an application programming interface (API). The API may be exposed by a computer program running on the computing device 102 that is separate from the operating system. Programs may not have access to the secondary GUI area 404 until they register with this gatekeeper computer program via the API, and indeed in one implementation until they are approved by a developer or other entity associated with the gatekeeper program.

Maintaining relatively controlled access of the secondary GUI area 404 in this way can ensure that the overall look and feel of the GUI area 404 stays consistent to maximize user experience, as well as to ensure the integrity of the secondary GUI area 404. Furthermore, the developer or other entity of the gatekeeper computer program can develop a software ecosystem akin to an “app store,” by which users have a central location from which to select controls that can be displayed within the secondary GUI area 404. Insofar as the developer or other entity approves the controls prior to their inclusion within the “store” for download by end users, the overall quality of the controls that can be added to the secondary GUI area 404 can also be maintained.

The secondary GUI area 404 displays in the area 416 operable GUI controls 422 for operating system-wide settings of the operating system running on the computing device 104 and via which the application programs also running on the computing device 104 are executed. The operable GUI controls 422 may be in the form of buttons and other types of controls, including search boxes, color wheels, slider controls, and so on. Such system-wide settings can include display brightness, audio volume, and so on. The system-wide settings can include system-wide functionality revealed at the operating system level, such as search capability by which a user enters in a search query and receives in response the documents and programs on the computing device 102 relevant to this query.

The example operation of FIG. 4 thus depicts example usage scenarios of the isolated secondary GUI area 404 in the selectable mode of the display device 102 in which the second area 204 of the contiguous planar display 106 is a separate display from a primary display of the first area 202 used for a primary GUI area 402. These usage scenarios include using an area 412 of the secondary GUI area 404 for operable GUI controls 418 related to the application program having focus in the primary GUI area 402. The usage scenarios include using an area 414 of the secondary GUI area 404 for operable GUI controls 420 related to application programs running in the background on the computing device 104, such as widget and other application programs that may access the secondary GUI area 404 via an API. The usage scenarios include using an area 416 of the secondary GUI area 404 for operable GUI controls 422 related to operating system-wide settings. The usage scenarios can be used in any combination.

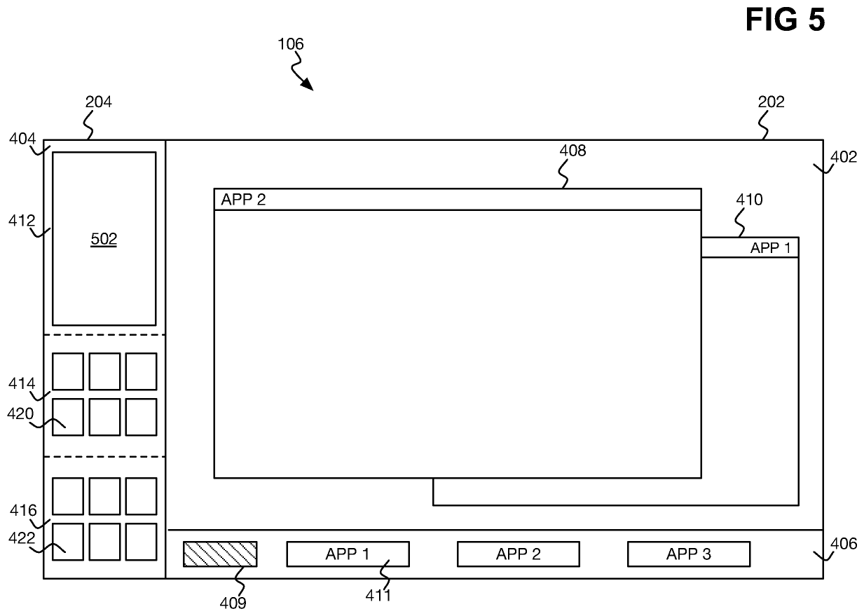

FIG. 5 shows another example operation of the display device 102 in the selectable mode in which the computing device 104 uses the first area 202 of the contiguous planar display 106 as a primary GUI area 402 and the second area 204 of the planar display 106 as an isolated secondary GUI area 404. The computing device 104 may achieve the example operation of FIG. 5 by executing the code 116 stored on the medium 114 to operate the primary display of the first area 202 of the display 106 as the primary GUI area 402, and by executing the code 116 to operate the secondary display of the second area 204 as the secondary GUI area 404. In the example of FIG. 5, the second area 204 is to the left of the first area 202, as in FIG. 4. Also as in FIG. 4, in the primary GUI area 402 in FIG. 5, an operating system can expose GUI elements such as a taskbar 406 including a start or main button 409, and buttons or icons 411 corresponding to actively running programs. The operating system can further display GUI elements in the primary GUI area 402 such as windows 408, 410 for the actively running application programs.

In the secondary GUI area 404, the area 412 corresponding to the application program that currently has focus within the primary GUI area 402 has a staging area 502 in FIG. 5 in lieu of the operable GUI controls 418 as in FIG. 4. The staging area 502 may be displayed responsive to selection of a particular operable GUI control 418 in FIG. 4. The staging area 502 permits a user to preview changes to a main GUI of the application program that currently has focus within the primary GUI area 402, prior to committing the changes from the staging area 502 to the main GUI. In FIG. 5, for instance, the main GUI may be the window 408, which is the top-most window of the primary GUI 402 and thus the window 408 for the application program that currently has focus. The staging area 502 may be considered a staging GUI.

For example, the application program that currently has focus within the primary GUI area 402 and that has the window 408 in the primary GUI area 402 as its main GUI may be a drawing or illustration program. The drawing or illustration program may permit a user to choose from a variety of different types of pen textures and patterns. The user may not be well acquainted with all of these different pen textures and patterns, and may further have substantially completed a drawing or illustration within the window 408. To try out, or preview, different pen textures and patterns, therefore, the user may spawn another window within the primary GUI area 402 as a scratchpad area. However, this approach is decidedly not optimal, because the user may have to switch between the temporary scratchpad area window and the window 408 multiple times to get a sense for how the pen textures and patterns will look within drawing or illustration under construction.

By comparison, the staging area 502 of the secondary GUI area 404 can permit the user to try out, or preview, different pen textures and patterns, for example, before selecting, or committing, a particular pen texture or pattern to the drawing or illustration within the window 408 in the primary GUI area 402. The staging area 502 may be a blank scratchpad area that the user can try out different pen textures and patterns, for instance. As another example, a portion of the drawing or illustration within the window 408 may be copied to the staging area 502. The user can thus try out different pen textures and patterns on this portion of the drawing or illustration in the staging area 502, and once have selected a desired pen texture or pattern, commit the selection to the drawing or illustration as a whole within the window 408. The staging area 408 may be employed in other ways as well to preview changes to the main GUI of the application that has focus in the primary GUI area 402.

The secondary GUI area 404 in FIG. 5 can include the area 414 including operable GUI controls 420 for background-running application programs, and/or the area 416 including operable GUI controls 422 for operating system-wide settings. However, if the user wishes for the staging area 502 to be larger—i.e., for the area 412 in which the staging area 502 is located to be larger—either or both of the areas 414 and 416 can be turned off so that they are not displayed. In such instance, the area 412 and the staging area 502 correspondingly increase in size.

FIGS. 2, 3, 4, and 5 that have been described pertain to a selectable mode of the display device 102 in which a first area 202 of the contiguous planar display 106 of the display device 102 functions as a primary display and a second area 204 of the planar display 106 functions as a separate secondary display. This selectable mode may be considered a first selectable mode. A user may select this selectable mode in a number of different ways. For instance, the display device 102—such as the system 100 of which the display device 102 is a part when the display device 102 is integrated with the computing device 104—may include a physical switch that the user can actuate. The user may select the mode in software as well, via a corresponding operable GUI control.

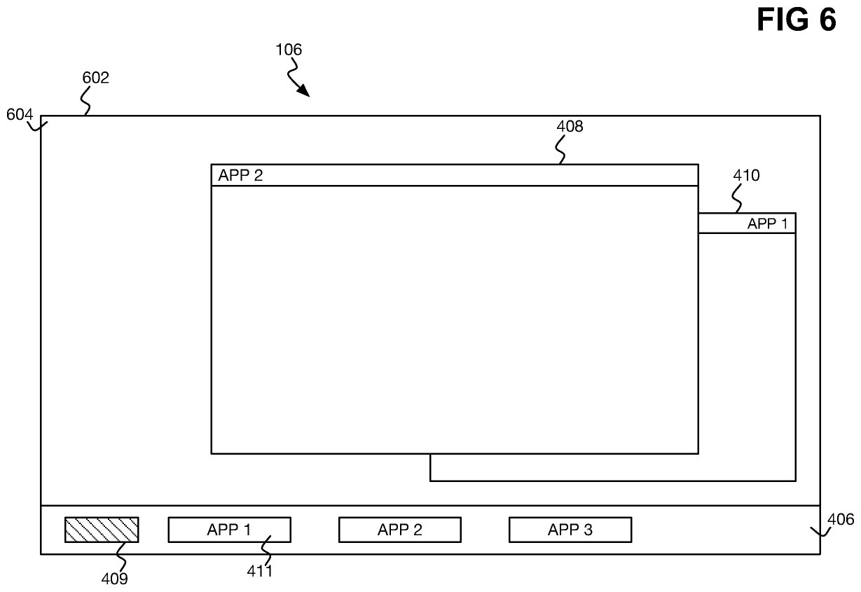

FIG. 6 shows an example operation of the display device 102 in another, second selectable mode. In the second selectable mode in FIG. 5, an entire area 602 of the contiguous planar display 106 of the display device 106 functions as a single contiguous display. The computing device 104 operates the display device 102 in this second selectable mode by using the entire area 602 as a primary GUI area 604. Therefore, a user can switch between the selectable mode of FIG. 5 and the selectable mode of FIGS. 2, 3, 4, and 5, via a physical switch or via software, to use the display 106 in a desired manner.

For instance, when the user switches the display device 102 from the first selectable mode of FIG. 4 or FIG. 5 to the second selectable mode of FIG. 6, the secondary GUI area 404 of FIGS. 4 and 5 is no longer displayed. Rather, the primary GUI area 402 of FIGS. 4 and 6 becomes the primary GUI area 604, taking up the entire area 602 of the display 106 of the display device 102. As such, the operating system can extend the taskbar 406, which includes a start or main button 409 and buttons or icons 411 corresponding to actively running programs, to take up the entire width of the display 106 in FIG. 6. The computing device 104 may achieve the example operation of FIG. 6 by executing the code 116 stored on the medium 114 to operate the primary display of the entire area 602 of the display 106 as the primary GUI area 402.

When the display device 102 is switched from the selectable mode of FIG. 4 or FIG. 5 to the selectable mode of FIG. 6, the windows 408, 410 displayed in the primary GUI area 402 of FIGS. 4 and 5 may remain in the same location in the primary GUI area 604 in FIG. 6, even though the primary GUI area 604 in size includes both the primary GUI area 402 and the secondary GUI area 404 of FIGS. 4 and 5. In this case, the extra space afforded to the primary GUI area 604 by the removal of the secondary GUI 404 can initially be blank or empty, but to which GUI elements like the windows 408, 410 can subsequently be moved. This implementation is specifically depicted in FIG. 6. In another implementation, when the display device 102 is switched form the selectable mode of FIG. 4 or FIG. 5 to the selectable mode of FIG. 6, the windows 408, 410 displayed in the primary GUI area 402 of FIGS. 4 and 5 can be re-centered width-wise to take account of the greater width of the primary GUI area 604 in FIG. 6 as compared to the width of the primary GUI area 402 in FIGS. 4 and 5.

When a user restarts or reboots, or powers off and then later powers on, the computing device 104, the display device 102 may operate in the selectable mode in which the display device 102 was operating previously. In another implementation, when a user restarts or reboots, or powers off and then later powers on, the computing device 104, the display device 102 may revert to operation in a default selectable mode, regardless of the selectable mode in which the display device 102 was operating previously. The user may be able to set which selectable mode is the default selectable mode of the display device 102, including the last used selectable mode as the default selectable mode.

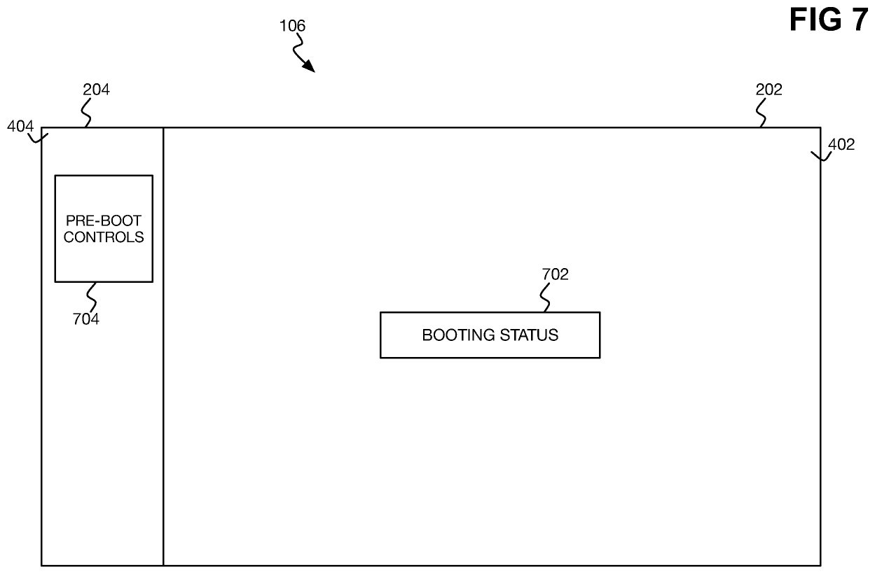

FIG. 7 shows an example operation of the display device 102 in the selectable mode 102 during a pre-boot environment of the computing device 104, in which the computing device 104 uses the first area 202 of the contiguous planar display 106 as a primary GUI area 402 and the second area 204 of the planar display 106 as an isolated secondary GUI area 404. At power-on, restart, or reboot of the computing device 104, a length of time may transpire while the operating system loads and fully boots prior to being ready for use by a user. During this time, the computing device 104 uses the primary GUI area 402 to display booting status information 702 regarding the loading and booting process of the operating system. For instance, such information 702 can include the logo and/or the name of the manufacturer of the computing device 104 and/or the developer of the operating system.

The time prior to the operating system loading and being ready for use by the user can be referred to as pre-boot of the computing device 104. In such a pre-boot environment (i.e., during pre-boot), the user may have the ability to modify lower-level firmware settings of the computing device 104, such as basic input/output system (BIOS) or extensible firmware interface settings of the computing device 104. Usually this is achieved by a user pressing a certain key or a certain key combination on a keyboard of the computing device 104 during pre-boot. However, the particular key or key combination can vary by manufacturer. Therefore, a user may have to restart or reboot the computing device 104 a number of times before he or she guesses the correct key or key combination to “enter” the BIOS or extensible firmware interface of the computing device 104 to change the settings thereof.

By comparison, in the example of FIG. 7, the computing device 104 uses the secondary GUI area 404 to display pre-boot controls 704 during pre-boot of the computing device 104, until the operating system has finished booting. The computing device 104 may initially display as the pre-boot controls 704 an instruction as to the key or key combination for the user to depress to display the BIOS or extensible firmware interface menu by which the settings thereof can be modified. In another implementation, the computing device 104 may immediately display the BIOS or extensible firmware interface menu, permitting the user to navigate the menu to change BIOS or extensible firmware interface settings during pre-boot. As such, the user does not have to guess the particular key or key combination to depress to “enter” the BIOS or extensible firmware interface of the computing device 104. The computing device 104 may achieve the example operation of FIG. 7 by executing the code 116 stored on the medium 114 to operate the primary display of the first area 202 of the display 106 as the primary GUI area 402, and by executing the code 116 to operate the secondary display of the second area 204 as the secondary GUI area 404.

Once the operating system has finished booting on the computing device 104 and is ready for use, the display device 102 may operate in a particular selectable mode as has been described. For instance, in one implementation, the display device 102 may operate in the selectable mode in which the display device 102 was operating prior to reboot, restart, or power-off, or may operate in a default selectable mode. In this respect, if the last selectable mode or the default selectable mode is the selectable mode in which the display device 102 uses an entire area 602 of the planar display 106 as a single contiguous display (per FIG. 6), the display device 102 still operates as has been described in accordance with FIG. 7 until the operating system has finished booting. That is, during pre-boot, the display device 102 operates in the selectable mode in which the first area 202 of the display 106 functions as a primary display and the second area 204 of the display functions as a separate secondary display, and once the operating system has finished booting, the display device 102 operates in the selectable mode in which the entire area 602 of the display 106 is used as a single contiguous display.

The techniques that have been described herein thus pertain to different implementations and usage scenarios regarding a contiguous planar display of a display device. The implementations relate to different ways to achieve operation of the display device in a selectable mode in which the planar display has a first area functioning as a primary display and a second area coplanar with and smaller than the first area functioning as a separate secondary display. The usage scenarios relate to different ways by which a computing device can operate the display device in this selectable mode by using the first area of the planar display as a primary GUI area and by using the second area of the planar display as an isolated secondary GUI area.

We claim:

1. A system comprising:
a display device having a contiguous planar display and operable in a selectable mode in which the planar display has a first area functioning as a primary display and a second area coplanar with and smaller than the first area functioning as a secondary display separate from the primary display; and
a computing device to operate the display device in the selectable mode by using the first area of the planar display as a primary graphical user interface (GUI) area and by using the second area of the planar display in the selectable mode as a secondary GUI area isolated from the primary GUI area.

2. The system of claim 1, wherein the computing device comprises:
a processor; and
a non-transitory computer-readable data storage medium storing program code that the processor executes to, in the selectable mode of the display device, divisibly virtualize the contiguous planar display into the first area functioning as the primary display and the second area functioning as the secondary display separate from the primary display.

3. The system of claim 1, wherein the computing device comprises:
graphical processing unit (GPU) hardware to, in the selectable mode of the display device, divisibly virtualize the contiguous planar display into the first area functioning as the primary display and the second area functioning as the secondary display separate from the primary display.

4. The system of claim 1, wherein the display device comprises:
a single physical display implementing the contiguous planar display; and
scaler or timing controller hardware to, in the selectable mode of the display device, expose the contiguous planar display to the computing device as the primary display and the secondary display separate from the primary display.

5. The system of claim 1, wherein the display device comprises:
a plurality of separate, contiguously arranged physical displays implementing the contiguous planar display; and
controller hardware to, in the selectable mode of the display device, expose to the computing device a first contiguous subset of the physical displays as the primary display and a second contiguous subset of the physical displays as the secondary display.

6. The system of claim 1, wherein the contiguous planar display is a multi-touch display,
and wherein in the selectable mode of the display device, multi-touch is disabled in the first area of the planar display functioning as the primary display and the multi-touch is enabled in the second area of the planar display functioning as the secondary display separate from the primary display.

7. The system of claim 1, wherein in the selectable mode, the computing device is to display in the secondary GUI area of the second area of the planar display a plurality of operable GUI controls particular to an application that currently has focus in the primary GUI area of the first area of the planar display and that is running on the computing device.

8. The system of claim 7, wherein in the selectable mode, the computing device is to further display in the secondary GUI area of the second area of the planar display a plurality of operable GUI controls for operating system-wide settings of an operating system running on the computing device and on which the application runs.

9. The system of claim 7, wherein in the selectable mode, the computing device is to further display in the secondary GUI area of the second area of the planar display a plurality of operable GUI controls particular to an application that currently does not have focus in the primary GUI area of the first area of the planar display and that is background-running on the computing device.

10. The system of claim 1, wherein in the selectable mode, the computing device is to display in the secondary GUI area of the second area of the planar display a plurality of operable GUI controls particular to a widget application background-running on the computing device and accessing the secondary GUI area via an application programming interface (API) for the secondary GUI area.

11. The system of claim 1, wherein in the selectable mode, the computing device is to display in the secondary GUI area of the second area of the planar display a staging GUI of an application that currently has focus in the primary GUI area of the first area of the planar display and that is running on the computing device,
wherein the staging GUI permits previewing changes to a main GUI of the application in the primary GUI area prior to committing the changes from the staging GUI to the main GUI.

12. The system of claim 1, wherein at power-on or restart of the computing device, the secondary GUI area is accessible as part of a pre-boot environment of the computing device while an operating system boots in relation to the primary GUI area and until the operating system has finished booting.

13. The system of claim 1, wherein the selectable mode is a first selectable mode, the display device operable in a second selectable mode in which an entire area of the planar display functions as a single contiguous display,
and wherein the computing device is to operate the display device in the second selectable mode by using the entire area of the planar display as the primary GUI area.

14. A display device comprising:
an interface to connect the display device to a computing device;
a contiguous planar display; and
hardware operable in a selectable mode of the display device to expose the planar display to the computing device via the interface as a primary display encompassing a first area of the planar display and as a separate secondary display encompassing a second area of the planar display coplanar with and smaller than the first area.

15. A non-transitory computer-readable data storage medium storing program code executable by a computing device to:
operate a primary display of a contiguous planar display as a primary graphical user interface (GUI) area, the primary display encompassing a first area of the planar display; and
operate a secondary display of the contiguous planar display as a secondary GUI area isolated from the primary GUI area, the secondary display encompassing a second area of the planar display coplanar with and smaller than the first area.
